(19) United States
(12) Patent Application Publication
(10) Pub. No.: US 2022/0270500 A1
(43) Pub. Date: Aug. 25, 2022

(54) INFORMATION PROCESSING APPARATUS, INFORMATION PROCESSING METHOD, AND PROGRAM

(71) Applicant: SONY GROUP CORPORATION, TOKYO (JP)

(72) Inventor: NOBUHIRO TSUNASHIMA, TOKYO (JP)

(21) Appl. No.: 17/597,219

(22) PCT Filed: Jun. 30, 2020
(86) PCT No.: PCT/JP2020/025717

§ 371 Date: Dec. 29, 2021

(30) Foreign Application Priority Data
Jul. 8, 2019 (JP) 2019-126952

(51) Int. Cl. G09B 5/02

(52) U.S. Cl. CPC G09B 5/02; G06Q 50/20

(57) ABSTRACT

There is provided an information processing apparatus including: a group evaluation unit configured to evaluate a group on a basis of a creation guideline for the group, and on a basis of a plurality of evaluation values associated with each of a plurality of members constituting the group; and a presentation control unit configured to perform control to present information items based on results of the evaluation of the group by the group evaluation unit.

### CROSS REFERENCE TO RELATED APPLICATIONS

This application claims the benefit of Japanese Priority Patent Application JP 2019-126952 filed Jul. 8, 2019, the entire contents of which are incorporated herein by reference.

### TECHNICAL FIELD

The present technology relates to an information processing apparatus, an information processing method, and a program. In particular, the present technology relates to a technical field of assistance in group creation at times of doing some group activity.

### BACKGROUND ART

In recent years, in lectures or classes at school or the like, a style that allows students to proactively learn is now being introduced to replace a style in which the students passively learn from teachers. Such a style that allows the students to proactively learn is called “Active Learning.” Generally, in the active learning, all the students belonging to a class are separated into groups each including a plurality of members, and proceed with the learning through mutual teaching or discussions in the groups.

Normally, the active learning is implemented a plurality of times in a period on a predetermined basis such as a yearly basis. In order to properly evaluate the students from results of the active learning implemented the plurality of times, a grouping in each of the times of the active learning is important. If the group is constituted by the same students each time, problems such as fixation of roles in the group and a bias in the number of statements occur. As a result, it is difficult to properly evaluate the students.

Thus, in the active learning to be implemented the plurality of times, the grouping of the students needs to be properly varied. However, there are countless grouping combinations of the students, and hence contemplating a proper grouping each time is a heavy burden on the teachers. In view of such circumstances, technologies to automate or to assist the grouping have been desired.

For example, with a focus on a correlation between a facilitator and a time period of a discussion to be led by the facilitator, Patent Literature 1 listed below discloses a technology to select the facilitator such that time periods of discussions to be led respectively by the students are equalized to each other, the technology including recording who is the facilitator and the time period of the discussion to be led by the facilitator in each time of the active learning.

Further, Patent Literature 2 listed below discloses a technology including prespecifying a student to be a training standard, checking an evaluation score of this student in each time of the active learning, and recording a grouping by which the evaluation score sharply increased, and groupings by which the evaluation score did not increase, thereby allowing determination of an optimum grouping for the student.

Still further, Patent Literature 3 listed below discloses a technology including recording opinions of the students in the active learning, and grouping students with similar opinions into the same group, thereby assisting the students to have further deep discussions.

### CITATION LIST

### Patent Literature

### [PTL 1]

Japanese Patent Application Laid-open No. 2016-110564

### [PTL 2]

Japanese Patent Application Laid-open No. 2015-90452

### [PTL 3]

Japanese Patent Application Laid-open No. 2015-28709

### SUMMARY

### Technical Problem

However, all the above-mentioned related-art technologies are biased to some extent. Specifically, the selection of the facilitator of the discussion by the technology of Patent Literature 1 has a disadvantage of repeatedly selecting a good facilitator as the facilitator. Further, by the technology of Patent Literature 2, since the grouping is performed in a manner that the student to be the training standard is a centerpiece, training of other students is unlikely to be taken into account. Still further, although the technology of Patent Literature 3 may allow the further deep discussions by gathering the students in the same opinion, opportunities of discussions from diverse viewpoints may be lost.

In view of the above-described circumstances, there is a need to increase a capability in assisting group creation.

### Solution to Problem

An information processing apparatus according to an embodiment of the present technology includes:
a group evaluation unit configured to evaluate a group
   on the basis of a creation guideline for the group, and
   on the basis of a plurality of evaluation values associated with each of a plurality of members constituting the group; and
a presentation control unit configured to perform control to present information items based on results of the evaluation of the group by the group evaluation unit.

This enables not only creation of groups having specific features, but also assistance in creation of diverse groups in accordance with creation guidelines.

In the information processing apparatus according to the embodiment of the present technology,
the group may be a group in which the plurality of members has conversations with each other.

This configuration enables assistance in creating, in accordance with creation guidelines, diverse groups in which members have conversations with each other, such as groups at times of discussions, fora, meetings, and the active learning.

In the information processing apparatus according to the embodiment of the present technology,
the group evaluation unit may evaluate the group while increasing weighting to at least one or more evaluation values relevant to the creation guideline of the plurality of evaluation values higher than weighting to other ones of the plurality of evaluation values.

This configuration enables proper evaluation of the group in accordance with the creation guideline for the group.

In the information processing apparatus according to the embodiment of the present technology,
the creation guideline may be selected from a plurality of creation guidelines, and
the group evaluation unit may evaluate the group while increasing weighting to at least one or more evaluation values relevant to the selected creation guideline of the plurality of evaluation values higher than weighting to other ones of the plurality of evaluation values.

This configuration enables proper evaluation of the group in accordance with the group creation guideline selected from the plurality of group creation guidelines.

In the information processing apparatus according to the embodiment of the present technology,
the creation guideline may be a group activity guideline relating to an activity policy of the group.

The group activity guideline relating to the activity policy of the group can be translated into a guideline relating to an object of an activity of the group. As examples of the group activity guideline, there may be mentioned guidelines of prompting the members to express diverse opinions (exploring diversity of the members), stimulating discussions, prompting the members to have discussions in a certain direction, and the like.

In the information processing apparatus according to the embodiment of the present technology,
the plurality of creation guidelines may include a deliverable guideline relating to quality of deliverables from the group.

As examples of the deliverable guideline relating to the quality of the deliverables from the group, there may be mentioned guidelines for obtaining high-quality deliverables, more specifically, guidelines such as a guideline of grouping competent students with each other. Alternatively, there may be mentioned guidelines for enriching a specific knowledge, more specifically, guidelines such as a guideline of grouping students who take a specific subject with each other.

In the information processing apparatus according to the embodiment of the present technology,
the at least one or more evaluation values of the plurality of evaluation values may include
   an evaluation value of an ability of a corresponding one of the plurality of members in a group activity, and
when the deliverable guideline has been selected as the creation guideline, the group evaluation unit may evaluate the group while increasing weighting to the at least one or more evaluation values higher than the weighting to the other ones of the plurality of evaluation values.

This configuration enables evaluation of the group based on the abilities of the members correspondingly to the case where the deliverable guideline has been selected as the creation guideline.

In the information processing apparatus according to the embodiment of the present technology,
the at least one or more evaluation values of the plurality of evaluation values may include any of
   a statement time period of a corresponding one of the plurality of members,
   a number of conversations of the corresponding one of the plurality of members, and
   a number of times when the corresponding one of the plurality of members has ever been grouped into a same group with other ones of the plurality of members, and
when a guideline other than the deliverable guideline has been selected as the creation guideline, the group evaluation unit may evaluate the group while increasing weighting to the at least one or more evaluation values higher than the weighting to the other ones of the plurality of evaluation values.

This configuration enables evaluation of the group based on the statement time periods of the members, the numbers of conversations of the members, or the numbers of times when the members have ever been grouped into the same group with the other members correspondingly to the case where the guideline other than the deliverable guideline has been selected as the creation guideline.

In the information processing apparatus according to the embodiment of the present technology,
the group evaluation unit may include a tentative-group creation unit configured to create a tentative group being a group that the group evaluation unit evaluates.

This configuration saves a user from manually arranging the tentative groups.

In the information processing apparatus according to the embodiment of the present technology,
the tentative group that the tentative-group creation unit creates may include a plurality of tentative groups, and
the group evaluation unit
   may evaluate, on the basis of the creation guideline, each of the plurality of tentative groups created by the tentative-group creation unit, and
   may calculate an overall evaluation value of all the plurality of tentative groups on the basis of the evaluation of each of the plurality of tentative groups.

With this configuration, the group overall-evaluation value indicating results of the evaluation of all the groups can be obtained correspondingly to a case where the plurality of groups should be created.

In the information processing apparatus according to the embodiment of the present technology,
the tentative-group creation unit may sequentially update combinations of members in the tentative group, and
the group evaluation unit may evaluate the tentative group in each of the updates.

This configuration enables a search for a group constitution by which high evaluation is obtained.

In the information processing apparatus according to the embodiment of the present technology,
the tentative-group creation unit may randomly vary the combinations of the members in each of the updates.

This configuration prevents, for example, a specific bias in combinational variation by the updates, such as a fixed grouping of specific members into the same group despite the repetitive updates.

In the information processing apparatus according to the embodiment of the present technology,
the updates by the tentative-group creation unit may include updates of regularly varying a part of a constitution of the tentative group.

This configuration enables the number of times of the group updates that are needed for increasing the evaluation of the tentative groups to a certain value or more to be reduced less than that in the case of performing the updates of randomly varying the combinations of the members.

In the information processing apparatus according to the embodiment of the present technology,
the tentative-group creation unit may end the updates when a number of times of the updates has reached a predetermined number of times or more.

This prevents unnecessary repetition of the updates.

In the information processing apparatus according to the embodiment of the present technology,
the tentative-group creation unit may switch techniques to create the tentative group in accordance with the creation guideline.

For example, when the guideline of exploring diversity of the members has been set, the tentative groups are created by randomly combining the members with each other. Meanwhile, when the guideline of grouping competent members with each other has been set, some of the tentative groups are created only with members each with the ability evaluation value of a certain value or more, and the rest of the tentative groups are created by randomly combining members each with the evaluation value of less than the certain value. In such a way, the techniques to create the tentative groups are switched in accordance with the creation guidelines.

In the information processing apparatus according to the embodiment of the present technology,
the tentative group that the tentative-group creation unit updates may include a plurality of tentative groups, and
the tentative-group creation unit may update the plurality of tentative groups in a manner that a condition that designated ones of the members are grouped into a same one of the plurality of tentative groups or separated into different ones of the plurality of tentative groups is satisfied.

This configuration enables reliable grouping of recommended members in a combination into the same tentative group and reliable separation of unrecommended members in a combination into different tentative groups.

In the information processing apparatus according to the embodiment of the present technology,
the presentation control unit may perform control to present an information item about a group constitution of a selected one of the plurality of tentative groups, the selected one being selected on the basis of results of the evaluation by the group evaluation unit.

This configuration enables the user to be presented with a group-constitution information item of a tentative group estimated to be suited to the creation guideline, such as a group-constitution information item of a tentative group that was evaluated highest.

In the information processing apparatus according to the embodiment of the present technology,
the presentation control unit may perform control to present an information item about arrangement relationships between members in the selected one of the plurality of tentative groups as the information item about the group constitution of the selected one of the plurality of tentative groups.

This saves the user from determining each time the arrangement relationships between the students in the group, such as a seating order of the members in the group.

Further, an information processing method according to another embodiment of the present technology includes:
evaluating, by an information processing apparatus, a group
   on the basis of a creation guideline for the group, and
   on the basis of a plurality of evaluation values associated with each of a plurality of members constituting the group; and
performing, by the information processing apparatus, control to present information items based on results of the evaluation of the group.

Also by such an information processing method, functions and advantages similar to those of the above-described information processing apparatus according to the embodiment of the present technology can be obtained.

Still further, a program according to still another embodiment of the present technology causes an information processing apparatus to implement:
a function to evaluate a group
   on the basis of a creation guideline for the group, and
   on the basis of a plurality of evaluation values associated with each of a plurality of members constituting the group; and
a function to perform control to present information items based on results of the evaluation of the group.

Such a program enables implementation of the functions of the above-described information processing apparatus according to the embodiment of the present technology.

### BRIEF DESCRIPTION OF DRAWINGS

FIG. 1 is a block diagram showing a configuration example of a group-creation assistance system including an information processing apparatus as an embodiment according to the present technology.

FIG. 2 is a view schematically showing a state of a group in active learning.

FIG. 3 is an explanatory flowchart showing a procedure of calculating statement time periods and the numbers of conversations.

FIG. 4 is a functional block diagram showing, in a block form, functions relating to a group-creation assistance technique as an embodiment.

FIG. 5 is a flowchart exemplifying processes to be executed for acquiring individual evaluation values.

FIG. 6 is a flowchart exemplifying processes to be executed at a time of implementing active learning after preliminaries.

FIG. 7 is a flowchart showing processes as a second modification.

FIG. 8 is a flowchart showing processes as a fifth modification.

### DESCRIPTION OF EMBODIMENTS

Now, an embodiment is described in the following order.

### <1. Configuration of Assistance System>

### <2. Group-Creation Assistance Technique as Embodiment>

### <3. Processing Procedure>

### <4. Various Modifications>

### [4-1. First Modification (Individual Evaluation Values)]

### [4-2. Second Modification (Creation Guideline)]

### [4-3. Third Modification]

### [4-4. Fourth Modification]

### [4-5. Fifth Modification]

### [4-6. Sixth Modification]

### [4-7. Seventh Modification]

### [4-8. Eighth Modification]

### [4-9. Ninth Modification]

### <5. Other Modifications>

### <6. Summary of Embodiment>

### <7. Present Technology>

### 1. CONFIGURATION OF ASSISTANCE SYSTEM

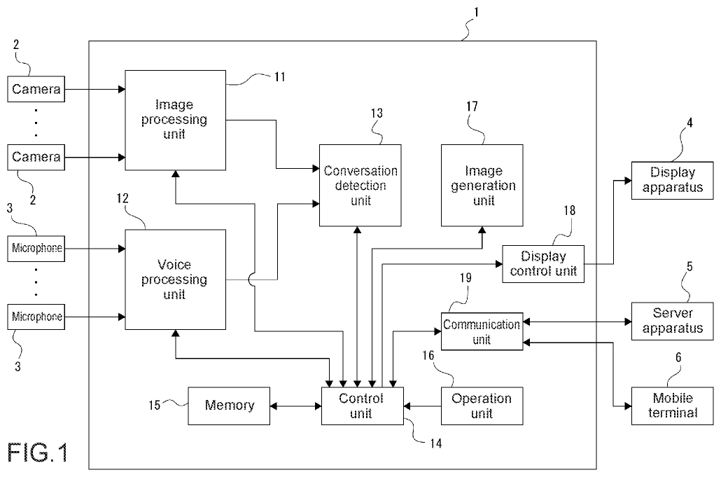

FIG. 1 is a block diagram showing a configuration example of a group-creation assistance system including an information processing apparatus 1 as an embodiment according to the present technology.

The assistance system of this embodiment is a system that assists group creation at times of doing required group activities. Specifically, the assistance system of this example assists creation of groups in which members have conversations with each other. More specifically, the assistance system of this example assists creation of groups for group activities as active learning that allows students at school to proceed with their study through discussions.

As shown in FIG. 1, the assistance system of this embodiment includes not only the information processing apparatus 1 but also a plurality of cameras 2, a plurality of microphones 3, a display apparatus 4, a server apparatus 5, and a mobile terminal 6.

The cameras 2 are each an imaging apparatus that captures the students participating in the active learning. The cameras 2 are each set mainly to capture the faces of the students as participants.

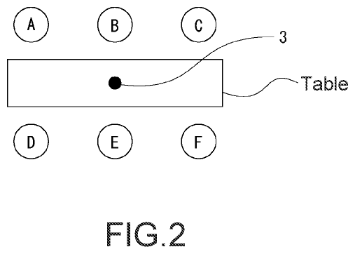

FIG. 2 schematically shows a state of a group in the active learning. In FIG. 2, the encircled “A” to “F” schematically indicate the students as the participants. In this example, a table and chairs as many as the students, which are arranged around the table, are prepared for the group of the active learning. The students participate in the active learning while being seated at their respective chairs.

In this example, the group for implementing the active learning includes a plurality of groups. As exemplified in FIG. 2, the cameras 2 shown in FIG. 1 are set respectively on the tables. In this case, in order that all the students in the group can be captured, a camera capable of capturing all the surroundings, such as a 360° camera, is used as the camera 2.

Note that, although one table is provided per group, and the number of the students per group is “6” in the case exemplified in FIG. 2, the numbers of the tables and the students per group are not limited thereto. Further, although the chairs are prepared as many as the students, the plurality of students may be seated at a long seat such as a bench.

Still further, the number of the cameras 2 per group need not necessarily be “1,” and the plurality of cameras 2 may be set such that all the surroundings can be captured.

In FIG. 1, the microphones 3 each detect a voice of a corresponding one of the students participating in the active learning. The microphones 3 may each be a microphone worn by the corresponding one of the students, or may be a plurality of microphones that form a microphone array to detect the voices of all the students.

Signals of images taken respectively by the cameras 2 and signals of the voices detected respectively by the microphones 3 are input to the information processing apparatus 1.

The information processing apparatus 1 calculates statement time periods and the number of conversations of the students in the active learning in response to these image signals and voice signals, and executes processes for the group creation assistance on the basis of these statement time periods and number of the conversations.

The display apparatus 4, which is a display apparatus capable of displaying images, such as a liquid-crystal display or the like, is connected to the information processing apparatus 1, and functions as a display device that displays various information items about the group creation assistance.

Further, the mobile terminal 6 is a portable information-processing apparatus that is assumed to be used by a teacher, such as a mobile phone, a tablet terminal, or the like. This mobile terminal 6, which is capable of performing data communication with the information processing apparatus 1, functions as another display device that displays the various information items about the group creation assistance.

Still further, the information processing apparatus 1 is capable of performing the data communication also with the server apparatus 5.

The information processing apparatus 1 also includes an image processing unit 11, a voice processing unit 12, a conversation detection unit 13, a control unit 14, a memory 15, an operation unit 16, an image generation unit 17, a display control unit 18, and a communication unit 19.

First, the image processing unit 11 can register therewith the respective faces of the participants at a stage of preparation of the active learning. Note that, when the voice of each of the participants is detected with the microphone to be worn by each of the participants, the respective faces of the participants to be registered and serial numbers of the microphones to be worn respectively by the participants may be associated with each other. This enables voice detection associated with each of the participants.

At the time of registering images of the respective faces of the participants, the respective faces of the participants are captured with the cameras (which may be cameras other than the cameras 2).

The image processing unit 11 executes a face detection process on the image signals (taken images) input from the cameras 2, thereby detecting positions and states of the respective faces of the participants. Viewing directions are detected as the states of the faces. The viewing directions are detected as orientations of the faces or line-of-sight directions. The technology as disclosed in “Japanese Patent Application Laid-open No. 2012-226665” may be adopted as a technology to detect the positions and the lines of sight. As a matter of course, other methods may be adopted. In this case, the image processing unit 11 performs individual identification by comparing the faces detected by the face detection process and the faces registered in advance to each other, thereby specifying to which of the detected faces the faces of the participants correspond respectively.

Note that, although, for example, the positions of the respective faces of the participants are determined by executing the face detection process on the images taken by the cameras 2 in the above description, the participants need not necessarily face the cameras 2. For example, at a time of writing on a whiteboard during a conversation, the faces of the participants may not be depicted in the images taken by the cameras 2. When the faces of the participants cannot be detected, places where the faces are detected last time are fixed as positions (face positions) of the participants. Alternatively, in this case, for example, by performing object tracking from the places where the faces disappear with use of an object tracking technology, the positions (face positions) of the participants may be updated. The technology as disclosed in “Japanese Patent Application Laid-open No. H6-169458” may be adopted as this object tracking technology. As a matter of course, other methods may be adopted.

The voice processing unit 12 processes the voice signals corresponding respectively to the participants, thereby detecting the respective statements of the participants participating in the active learning. Note that, when the voice detection is performed with the microphones 3 worn respectively by the participants, the voice processing unit 12 is allowed to easily grasp which of the detected voices the participants uttered respectively. In such a way, matching between the voices and the participants is performed.

Note that, when the voices are detected with the microphone array, as follows, the voice processing unit 12 is allowed to grasp which of the detected voices the participants uttered respectively. Specifically, the microphone array, which is set, for example, at the same position as that of or near the 3600 camera capable of capturing all the surroundings, detects the voices, and at the same time, detects directions in which the voices are uttered. Thus, with reference to information items about the positions of the respective faces of the participants, which are detected by the image processing unit 11 as described above, the voice processing unit 12 grasps which of the voices to be detected by the microphone array the participants utter respectively. In such a way, the matching between the voices and the participants is performed. Note that, although the technology as disclosed in “Japanese Patent Application Laid-open No. H9-251299” may be adopted as a technology to detect the directions of the voices with the microphone array, as a matter of course, other methods may be adopted.

The voice processing unit 12 processes the voice signals corresponding respectively to the participants, thereby detecting the respective statements of the participants participating in the active learning. In this case, for example, volume is measured from the respective voice signals of the participants, and the voice processing unit 12 determines that a statement has been made when the volume remains equal to or higher than a threshold for a predetermined time period or longer.

When the volume remains equal to or higher than the threshold for less than the predetermined time period, the voice processing unit 12 determines that an utterance to express agreement, disagreement, an interjection, or the like has been made, that is, determines that the statement has not been made.

The conversation detection unit 13 detects the conversations on the basis of the respective statements of the participants, which are obtained by the voice processing unit 12, and the respective states of the participants, which are obtained by the image processing unit 11. In this case, for example, when a second participant makes a statement, and at the same time, when a viewing direction of the second participant is a direction to the first participant after a first participant has made a statement, or immediately before an end of the statement, the conversation detection unit 13 determines that the first participant and the second participant have had a conversation with each other.

Note that, the conversation detection unit 13 may determine that the conversation has been had also when the viewing direction of the second participant is not the direction to the first participant. For example, the conversation detection unit 13 may determine that the conversation has been had, for example, also when the second participant utters after the first participant has made a statement, or when the second participant moves his/her head up and down (nods) after the first participant has made a statement.

The control unit 14 includes a microcomputer (arithmetic processing apparatus) including a CPU (Central Processing Unit), a ROM (Read Only Memory), a RAM (Random Access Memory), and the like. The RAM is used as a work area at times when the CPU executes various data processes, that is, used for temporarily storing data items, programs, and the like. The ROM is used for storing, for example, not only an OS (Operating System) that allows the CPU to control all the units, and content files such as image files, but also application programs for various operations, and firmware.

The control unit 14 comprehensively controls the information processing apparatus 1 by executing the programs stored in the ROM and the like.

In addition, the control unit 14 calculates the statement time period of each of the participants on the basis of results of the detection of the statements (statement intervals) of each of the participants, the detection being performed by the voice processing unit 12.

In addition, the control unit 14 calculates the numbers of the conversations of each of the participants on the basis of results of the detection of the conversations of each of the participants, the results being obtained by the conversation detection unit 13. These numbers of the conversations are calculated for each of the participants as the numbers of conversations with other ones of the participants. For example, when a total number of the students who participate in the active learning (that is, total number of the students in a class) is K, the respective numbers of conversations with the other K−1 students are calculated as the numbers of the conversations of each of the students.

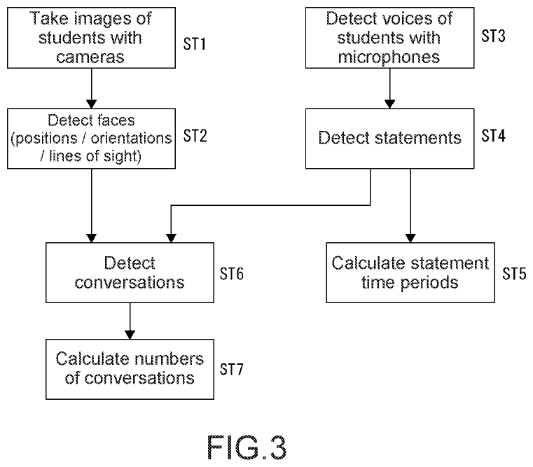

Now, with reference to the flowchart of FIG. 3, a procedure of calculating the statement time periods and the numbers of the conversations is described for confirmation.

In FIG. 3, first, in Step ST1, the images that depict all the students participating in the active learning are taken with all the cameras 2. Then, in Step ST2, the image processing unit 11 processes the signals of the taken images from all the cameras 2, thereby determining the positions and the states of the face of each of the participants, such as the viewing directions (orientations of the face or the lines of sight).

Next, in Step ST3, the voices of the students participating in the active learning are detected respectively with the microphones 3. After that, in Step ST4, the voice processing unit 12 processes the respective voice signals from the microphones 3, thereby detecting the statements of each of the students participating in the active learning.

Then, in Step ST5, the control unit 14 calculates the statement time periods on the basis of the results of the detection of the statements of each of the participants, the detection being performed by the voice processing unit 12.

In addition, in Step ST6, the conversation detection unit 13 detects the conversations on the basis of the results of the detection of the statements of each of the participants, the detection being performed by the voice processing unit 12, and on the basis of the states of each of the participants, which are detected by the image processing unit 11.

Then, in Step ST7, the control unit 14 calculates the numbers of the conversations of each of the participants on the basis of the results of the detection of the conversations of each of the participants, the results being obtained by the conversation detection unit 13.

Now, description is made with reference back to FIG. 1.

As shown in FIG. 1, the memory 15, the operation unit 16, the image generation unit 17, the display control unit 18, and the communication unit 19 are connected to the control unit 14.

The memory 15, which is a nonvolatile memory capable of writing and reading out of the data items generated by the control unit 14, is used for storing the various data items generated by the control unit 14. For example, the information items about the statement time periods of each of the participants, which are calculated by the control unit 14, and the numbers of the conversations are stored in this memory 15.

Input devices for allowing a user to input various operations are collectively shown as the operation unit 16. For example, the operation unit 16 includes a keyboard, a mouse, a touchscreen, and the like. The operation unit 16 detects the operations by the user, and outputs signals to the control unit 14 in response to the detected operations.

The image generation unit 17 generates images in response to instructions from the control unit 14.

The display control unit 18 causes the display apparatus 4 to display the images based on the instructions from the control unit 14. The display control unit 18 enables the control unit 14 to cause the display apparatus 4 to display various images such as the images that the control unit 14 causes the image generation unit 17 to generate and the like.

The communication unit 19 performs data communication with external apparatuses in a wired or wireless manner. The control unit 14 is capable of exchanging the various data items with the server apparatus 5 and the mobile terminal 6 via the communication unit 19.

### 2. GROUP-CREATION ASSISTANCE TECHNIQUE AS EMBODIMENT

First, preceding the description of a group-creation assistance technique as an embodiment, the active learning being a target of the group creation assistance is described.

The active learning being the target in this example is implemented a plurality of times in a period on a predetermined basis such as a yearly basis as a type of classes at school. The activities in each of the groups in the active learning are voluntarily done. Thus, a teacher does not stop at one of the groups for a long time period, but makes the rounds of all the groups, thereby appropriately supporting the activities in the groups. At this time, it is difficult for the teacher to stop at one of the groups, and it is relatively difficult for him/her to grasp details of the activities in the groups. The students are each evaluated on the basis of, for example, final deliverables from their group (such as reports and the like) or tests after the active learning. The assistance system in this example assists group creation in such active learning.

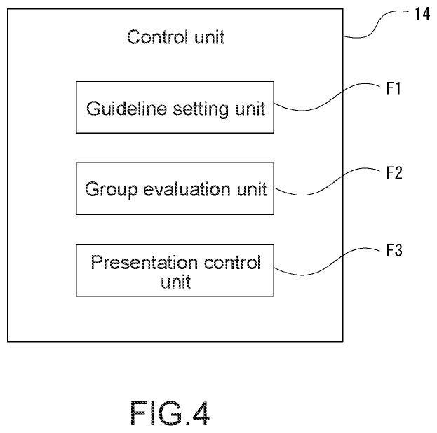

FIG. 4 is a functional block diagram showing, in a block form, functions of the control unit 14 in the information processing apparatus 1, which relate to the group-creation assistance technique as the embodiment.

As shown in FIG. 4, the control unit 14 has functions of a guideline setting unit F1, a group evaluation unit F2, and a presentation control unit F3.

The guideline setting unit F1 sets group creation guidelines. In other words, the guideline setting unit F1 sets guidelines about what kind of group to create. Specifically, in this example, the guideline setting unit F1 sets guidelines relating to an activity policy of the group (group activity guideline), such as a guideline of prompting members to express diverse opinions (exploring diversity of the members), stimulating discussions, prompting the members to have discussions in a certain direction, and the like.

Further, as an example of the guidelines relating to the activity policy of the group, there may be mentioned a guideline relating to quality of the deliverables from the group (deliverable guideline). As examples of this guideline, there may be mentioned, for example, guidelines for obtaining high-quality deliverables, more specifically, guidelines such as a guideline of grouping competent students with each other. Alternatively, there may be mentioned guidelines for enriching a specific knowledge, more specifically, guidelines such as a guideline of grouping students who take a specific subject with each other.

Still further, as another example of the guidelines relating to the activity policy of the group, there may be mentioned guidelines other than the above-mentioned guideline relating to the quality of the deliverables from the group. Specifically, the above-mentioned guideline of prompting the members to express the diverse opinions (exploring diversity of the members) and the like belong to the guidelines other than the guideline relating to the quality of the deliverables from the group.

In this example, the group creation guidelines can be set on the basis of the operations by the user. Alternatively, the control unit 14 can autonomously set the guidelines on the basis of conditions other than the operations.

The group evaluation unit F2 is configured to evaluate the groups with use of a plurality of evaluation values associated with each of the members in the groups.

Note that, in this example, first Nm times of the active learning (Nm is a natural number of two or more) of the plurality of times of the active learning to be implemented as a type of classes are implemented as preliminaries for obtaining individual evaluation values “v” of each of the students in the active learning.

In this example, evaluation values as follows are acquired as the individual evaluation values “v” of each of the students.
v1(n,k): Statement Time Period
v2(n,k,m): Number of Conversations
v3(n,k): Ability Evaluation Value
v4(n,k): Final-Deliverable Evaluation Value
v5(k,m): Number of Times When Corresponding One of Students Has Ever Been Grouped into Same Group with Other Ones of Students
v6(k,m): Differences in Gender from Other Ones of Students
v7(k,m): Differences in Age from Other Students

The statement time period v1 and the number of conversations v2 are respectively the statement time period and the number of conversations that the control unit 14 calculates as described above.

The ability evaluation value v3 is an evaluation value of an ability relating to the active learning of the student, for example, an evaluation value of an item relating to an ability that the teacher checks while making the rounds of all the groups during the active learning, such as an item “Content of Statement Is Good”. At this time, the evaluation value of each of the items is, for example, a value on a scale of 1 to 5, and a total value of all the items is input as the ability evaluation value v3 to the information processing apparatus 1.

The final-deliverable evaluation value v4 is an evaluation value of the final deliverable obtained through the group activity as the active learning. In this example, the final-deliverable evaluation value v4 is the report to be submitted by the student after the active learning. On a premise of this example, this evaluation value v4 is also input to the information processing apparatus 1 by the teacher.

These evaluation values v3 and v4 correspond to evaluation values of abilities of the student in the group activity, that is, a member constituting the group. Evaluation values of the abilities of the member in the group activity, such as the evaluation values v3 and v4, are evaluation values of abilities that the member exerts through the group activity.

In this context, in this example, the statement time period v1, the number of conversations v2, the ability evaluation value v3, and the final-deliverable evaluation value v4 listed above are acquired as values in each of the times of the active learning to be implemented the plurality of times. The “n” enclosed in the parentheses of each of the evaluation values is an identifier of the number of times of implementation for identifying in which turn of the active learning a corresponding one of the evaluation values is obtained. Further, the “k” enclosed in the parentheses is a student identifier for identifying to which of all the K students a corresponding one of the evaluation values is given, the K (K is a natural number of two or more) representing the total number of the students in a class, who take the class of the active learning. Still further, the “m” enclosed in the parentheses of the number of conversations v2 is an another-student identifier for identifying other students. Note that, the relationship k≠m is established. The number of conversations v2 is an evaluation value to be counted per conversational partner, and hence is influenced not only by the student identifier “k” but also by the another-student identifier “m.”

The evaluation value v5 of the number of times when a corresponding one of the students has ever been grouped into the same group with other ones of the students is a numerical value with respect to each of the other students, and hence is influenced not only by the student identifier “k” but also by the another-student identifier “m.” This evaluation value v5 is not a value per time of the active learning, but a sum at the plurality of times of the active learning to be implemented.

None of the evaluation value v6 of the differences in gender from the other ones of the students and the evaluation value v7 of the differences in age from the other ones of the students is a value to vary at each of the times of the active learning. Thus, these evaluation values are not influenced by the identifier “n” of the number of times of the implementation, and influenced by the student identifier “k” and the another-student identifier “m.”

In this example, the evaluation value v6 is “1” when a gender of a corresponding one of the students is different from that of another one of the students, and is “0” when his/her gender is the same as that of the other one of the students. Further, in this example, the evaluation value v7 is an absolute value of the difference in age from another one of the students.

Note that, it is conceivable that the evaluation value v5 is input by the user such as the teacher to the information processing apparatus 1 on the basis of respective results of the groupings implemented as the preliminaries. Alternatively, with regard to the respective groupings at the times of the active learning to be implemented as the preliminaries, combinations of the students (such as random combinations, combinations according to some regularity, or the like) in each of the groups may be determined by the information processing apparatus 1 (control unit 14). In that case, the information processing apparatus 1 itself may generate (calculate) the respective evaluation values v5 of the other students. As understood from the following description, in this example, the latter technique is adopted.

In addition, the evaluation value v6 and the evaluation value v7 may be input as numerical values directly to the information processing apparatus 1 by the user such as the teacher, or may be generated (calculated) by the information processing apparatus 1 itself on the basis of personal information items (information items about, for example, age and gender) of each of the students, which are input to and accepted by the information processing apparatus 1.

The group evaluation unit F2 evaluates a group to be adopted in the active learning after the preliminaries on the basis of the individual evaluation values “v” as described above, which are obtained as a result of the plurality of times of the active learning to be implemented as the preliminaries.

Note that, in this example, the control unit 14 creates groups to be candidates for groupings in the active learning after the preliminaries. Hereinafter, such groups as the candidates are referred to as “tentative groups.”

The control unit 14 evaluates the created tentative groups with the group evaluation unit F2, and determines whether or not these created tentative groups are recommended groups.

At this time, the group evaluation unit F2 evaluates the tentative groups with use of the individual evaluation values “v” of each of the students and on the basis of the creation guidelines set by the guideline setting unit F1. This enables the tentative groups to be evaluated on the basis of the creation guidelines, whereby creation of diverse groups in accordance with the creation guidelines can be assisted.

Now, a specific group-creation assistance technique with use of the group evaluation unit F2 for the active learning (an Nm+1ₛₜ time of the active learning) after the preliminaries is described. Here, an entirety of the class including the K students is divided into G groups (G is a natural number of two or more). First, the control unit 14 performs a tentative grouping. Specifically, the tentative grouping is performed such that all the K students belong to any of the G tentative groups. At the time of this grouping, combinations of the students may be randomly determined, or may be determined in the same way as that at an Nm-th time.

The group evaluation unit F2 evaluates all the G tentative groups created as described above with use of the individual evaluation values “v” of each of the students in each of the tentative groups, and on the basis of the creation guidelines set by the guideline setting unit F1. As examples of the creation guidelines to be set, there may be mentioned “exploring diversity of the students,” “grouping students having the same tendency with each other,” “grouping competent students with each other,” and the like.

In this example, for each of the creation guidelines that can be set by the guideline setting unit F1, weights “w” are preset for the individual evaluation values “v.” These preset weights “w” in this example includes a weight w1, a weight w2, a weight w3, a weight w4, a weight w5, a weight w6, and a weight w7 corresponding respectively to the above-described individual evaluation values v1 to v7.

For example, when the guideline of “exploring diversity of the students” has been set, it is desirable that students who have never been grouped into the same group be grouped into the same group as much as possible. Thus, the evaluation value v5 of the number of times when a corresponding one of the students has ever been grouped into the same group with other ones of the students is used. As the evaluation value v5 increases, the number of times when the corresponding one of the students has ever been grouped into the same group with the other ones of the students increases. Thus, in order to increase the evaluation value as the number of these times decreases, the weight w5 needs to be a negative value. Settings are made such that the evaluation value v5 is a value of zero or more, that the evaluation value with the weight is zero when the evaluation value v5 is zero, and that the evaluation value with the weight increases in the negative direction when the evaluation value v5 is a large positive value. At this time, if the negative evaluation value is undesirable, a constant may be added.

Further, for “exploring diversity of the students,” it is desirable that the ages and the genders of the students be different from each other as widely as possible. Thus, it is conceivable, for example, to increase proportions of the evaluation values v6 and v7 as well as the evaluation value v5. As described above, the evaluation value v6 is “1” when the genders are different from each other, and is “0” when the genders are the same as each other. Thus, this value increases as a bias of the genders becomes smaller. Therefore, it is appropriate to set the weight w6 to a positive value. In addition, the evaluation value v7 is the absolute value of the differences in age. Thus, this value increases as a bias of the ages becomes smaller. Therefore, it is appropriate to set the weight w7 to a positive value.

Still further, for “exploring diversity of the students,” it is desirable that the numbers of the conversations be small even when a corresponding one of the students has ever been grouped into the same group with other ones of the students. Thus, a proportion of the value of the number of conversations v2 is set high after, for example, the evaluation value v5. Similar to the evaluation value v5, as the value of the number of conversations v2 decreases, a group evaluation value increases. Therefore, the weight w2 is set to a negative value. In the case of “exploring diversity of the students,” the proportion of the evaluation value v5 is higher than that of the number of conversations v2, and hence an absolute value of the weight w5 is larger than an absolute value of the number of conversations v2. In a similar way, magnitudes of absolute values of the weights w1, w3, and w4, and whether these weights are positive or negative are determined.

Meanwhile, when the guideline of “grouping students having the same tendency with each other” has been set, it is desirable that the genders and the ages of the students be the same as each other as much as possible. Thus, with respect to this guideline, the proportions of the evaluation value v6 and the evaluation value v7 are increased. However, in this case, whether or not a corresponding one of the students has ever been grouped into the same group with other ones of the students is scarcely relevant to this guideline. Thus, the proportion of the evaluation value v5 is reduced without being increased as those of the evaluation value v6 and the evaluation value v7 are increased. In such a way, which of the individual evaluation values “v” to be increased in weight in accordance with the guideline of “exploring diversity of the students” and which of the individual evaluation values “v” to be increased in weight in accordance with the guideline of “grouping students having the same tendency with each other” are different from each other.

Note that, in the case of “grouping students having the same tendency with each other,” it is desirable that the genders and the ages be the same as each other, and hence it is appropriate to set each of the weight w6 of the evaluation value v6 and the weight w7 of the evaluation value v7 to a negative value.

In addition, in the case of “grouping students having the same tendency with each other,” it is also conceivable to group students who make long statements with each other, or grouping students who make short statements with each other. In that case, the weight w1 of the statement time period v1 is increased.

As described above, at the times of the group evaluation in accordance with the creation guidelines, of the plurality of individual evaluation values “v,” different ones of individual evaluation values “v” to be increased in weight are preset for each of the creation guidelines. In addition, as understood from the above description, combinations of the individual evaluation values “v” to be increased in weight are different from creation guideline to creation guideline. In other words, for each of the creation guidelines, (at least one or more of) the individual evaluation values “v” relevant to corresponding one of the creation guidelines are preset. In the group evaluation of this example, the group evaluation value is calculated while weighting to the individual evaluation value “v” relevant to designated one of the creation guidelines is increased higher than weighting to other ones of the individual evaluation values “v.”

Note that, the individual evaluation value “v” relevant to the creation guideline may be automatically or manually preset, of the plurality of individual evaluation values “v,” as the relevant individual-evaluation value “v” with respect to the creation guideline. In addition, the individual evaluation value “v” relevant to the creation guideline need not necessarily be fixed, and settings thereof may be changed.

Of the individual evaluation values “v,” one that has been determined as the relevant individual-evaluation value “v” with respect to certain one of the creation guidelines is increased in weight than other ones of the individual evaluation values “v” are increased in weight. In addition, when the relevant individual-evaluation value “v” with respect to the designated one of the creation guidelines includes a plurality of relevant individual-evaluation values “v,” these individual evaluation values “v” may be varied in weight in accordance with relevance to the designated one of the creation guidelines.

Note that, although the weights “w” are each set to a negative value in the case described above, depending on the guideline, the weights “w” of the same ones of the individual evaluation values “v” may appropriately be set positive or negative. For example, when the guideline of “grouping students having the same tendency with each other” has been set, it is desirable that students who have ever had active conversations with each other in the same group at a previous time of the active learning be regrouped into the other same group with each other. Thus, the weight w2 and the weight 5 should each be a positive value.

With regard to the weighting addition to be performed as described above with use of the weight w1 to the weight w7 preset for each of the guidelines, types of the individual evaluation values “v” are different from each other. Thus, problems may be caused if the weighting addition is simply performed. As a countermeasure, by applying correction functions respectively to the individual evaluation values “v,” the differences in type can be suppressed.
f1(v1(n,k)): Statement Time Period
f2(v2(n,k,m)): Number of Conversations
f3(v3(n,k)): Ability Evaluation Value
f4(v4(n,k)): Final-Deliverable Evaluation Value
f5(v5(k,m)): Number of Times When Corresponding One of Students Has Ever Been Grouped into Same Group with Other Ones of Students
f6(v6(k,m)): Differences in Gender from Other Ones of Students
f7(v7(k,m)): Differences in Age from Other Ones of Students

With regard to the correction function to correct the differences in age from other ones of the students, the following two measures are taken into account. The first measure is to equalize absolute magnitudes of numerical values to each other as much as possible. The second measure is to take saturation of the numerical values into account.

With regard to the first measure to equalize the absolute magnitudes of the numerical values to each other as much as possible, when the statement time period v1 is calculated on a “second” basis (or “minute basis” or “hourly basis”), the statement time period v1 is liable to be larger than the number of conversations v2. As a countermeasure, in order to equalize the absolute magnitudes of the numerical values to each other, the individual evaluation values “v” are multiplied respectively by a weighting coefficient μ 1, a weighting coefficient μ 2, a weighting coefficient μ 3, a weighting coefficient μ 4, a weighting coefficient μ 5, a weighting coefficient μ 6, and a weighting coefficient μ 7. Note that, it is appropriate to preset the weighting coefficients μ 1 to μ 7 on the basis of experiences.

With regard to the second measure to take the saturation of the numerical values into account, although the ability evaluation value v3 and the final-deliverable evaluation value v4 each have an upper limit, specifically, are each obtained, for example, on the scale of 1 to 5, the values of the statement time period v1, the number of conversations v2, and the evaluation value v5 are also finite but may be significantly large, which may cause the problems at the time of the weighting addition. In addition, increases of the values of the statement time period v1, the number of conversations v2, and the evaluation value v5 to certain values or more may be meaningless. For example, an increase in the number of conversations from one to two and an increase in the number of conversations from 100 to 101 are different increases by one in the number of conversations. As a countermeasure, functions in which the values are increased to be saturated, such as a logarithmic function (log X) and a sigmoidal function (1/(1+e^{-x})), may be applied, for example, to the evaluation values v1, v2, and v5. Specifically, the value f1(v1(n,k)) obtained by applying the correction function f1 to the evaluation value v1 is expressed by the following equation, where “*” is a multiplication sign.

f1(v1(n,k))=μ1*log(v1(n,k))

In addition, the evaluation value v3 and v4 that need not be saturated are expressed as follows.

f3(v3(n,k))=μ3*v3(n,k)

f4(v4(n,k))=μ4*v4(n,k)

In such a way, with use of the function in which the values are increased to be saturated, the evaluation values v1, v2, and v5 are handled as easily as the evaluation values v3 and v4.

Next, a technique to calculate a group evaluation value E(g) of each of the tentative groups is described. Note that, “g” is a group identifier for identifying all groups 1 to G. P(g) students belong to each of the groups. In this example, P(g) is not a fixed constant but a table function because the total number K of the students in a class may not be divided by G (the total number of the groups), or the students are not necessarily grouped evenly.

In addition, an intra-group identifier “p” being an identifier of each of the students in each of the groups is set. By preparing a table function “h,” association of the intra-group identifier “p” and the student identifier “k” is preset as h(p)=k. Further, an identifier of each of the students other than a student himself/herself in the group is represented by “q.”

At this time, the evaluation value E(g) of each of the tentative groups is expressed by the following equation.

E(g)=Σ^{N}ₙ₌₁{w1/P(g)*Σ^{P(g)}ₚ₌₁v1(n,h(p))+w2/(P(g)*(P(g)−1))*Σ^{P(g)}ₚ₌₁Σ^{P(g)}_{q=1}v2(n,h(p),h(q))+w3/P(g)*Σ^{P(g)}ₚ₌₁v3(n,h(p))+w4/P(g)*Σ^{P(g)}ₚ₌₁v4(n,h(p))}+w5/(P(g)*(P(g)−1))*Σ^{P(g)}ₚ₌₁Σ^{P(g)}_{q=1}v5(h(p),h(q))+w6/(P(g)*(P(g)−1))*Σ^{P(g)}ₚ₌₁Σ^{P(g)}_{q=1}v6(h(p),h(q))+w7/(P(g)*(P(g)−1))*Σ^{P(g)}ₚ₌₁Σ^{P(g)}_{q=1}v7(h(p),h(q))

Note that, since “q” represents the other student than the student himself/herself in the group, the relationship p≠q is established. However, application of this condition complicates the computational expression, and hence v2(n,h(p),h(p))=0, v5(h(p),h(p))=0, v6(h(p),h(p)), and v7(h(p),h(p)) are premised.

The group evaluation unit F2 calculates the respective evaluation values E(g) as described above of the tentative groups, and calculates a group overall-evaluation value Eall being an overall evaluation value of all the G tentative groups. The group overall-evaluation value Eall is, for example, a value of a sum of the group evaluation values E(g) as calculated by the following equation.

Eall=1/G*Σ^{G}_{g=1}E(g)

Note that, in order to avoid leaving groups that are poor in evaluation value E(g), a minimum one of the evaluation values E(g) may be used. Alternatively, in order to equalize the group evaluation values to each other, a variance of the evaluation values E(g) may be used.

In this example, the control unit 14 sequentially creates the G tentative groups while varying (updating) the combinations of the students who constitute the tentative groups. Then, the control unit 14 calculates the group overall-evaluation value Eall as described above of the newly created G tentative groups by implementing the function of the group evaluation unit F2. As described below, the control unit 14 executes a procedure including, for example, repeating such an update of the tentative groups and a calculation of the group overall-evaluation value Eall a plurality of times, and presenting, to the user such as the teacher, information items about respective group constitutions of the tentative groups at a time when a grouping by which a highest group-overall-evaluation value Eall was obtained was performed. This enables the group creation assistance by the presentation of a proper group constitution in accordance with the group creation guideline to the user.

Note that, the update of the respective group constitutions of the tentative groups may be performed by regularly varying parts of current group constitutions, or by randomly updating the parts of the current group constitutions. When the parts of the current group constitutions are randomly updated, the combinations of the students in each of the tentative groups are determined on the basis of random numbers. This enables the evaluation values of the groups to be likely to fluctuate in each update, which contributes to an increase in searching performance at a time of searching for a group constitution suited to the creation guideline. Further, in the case of regularly varying the parts of the constitutions, a technique including specifying, in each of the tentative groups, one to several ones of the students, who degrade the group evaluation value, and exchanging these students with another one of the groups may be adoped. This enables the number of times of the group updates that are needed for increasing the evaluation of the tentative groups to a certain value or more to be reduced less than that in the case of performing the updates of randomly varying the combinations of the students. In other words, this enables an increase in efficiency in searching for a group constitution.

The presentation control unit F3 is configured to perform control to present the information items based on the results of the evaluation of the groups by the group evaluation unit F2. Specifically, on a premise that the group evaluation unit F2 generates the group overall-evaluation value Eall in each of the updates of the tentative groups as described above, the presentation control unit F3 in this example executes a process for presenting, to the use such as the teacher, the information items about the respective group constitutions of the tentative groups at the time when the grouping by which the highest one of the group overall-evaluation values Eall was obtained was performed.

As the information items about the group constitutions, for example, information items containing respective identification-information items (such as names, identification numbers, or the like) of the students constituting the tentative groups are presented respectively for the tentative groups. The presentation control unit F3 performs control to cause the image generation unit 17 to generate an image containing such information items about the group constitutions, and to cause the image to be presented to the user such as the teacher via the display apparatus 4 or the mobile terminal 6.

Note that, instead of presenting the information items about the group constitutions corresponding to the highest one of the group overall-evaluation values Eall, information items about a plurality of top-ranked group constitutions corresponding to high ones of the group-overall-evaluation values Eall may be presented. In this case, the user such as the teacher is allowed to select a desired group constitution from among the plurality of presented group constitutions. At this time, not only the information items about the plurality of top-ranked group constitutions, but also the group overall-evaluation values Eall of these groups may be presented. Such “information items based on the results of the evaluation of the groups” for which the presentation control unit F3 performs the presentation control can contain not only the information items about the constitutions of the groups selected on the basis of the results of the evaluation but also the information items about the evaluation values calculated by the group evaluation unit.

### 3. PROCESSING PROCEDURE

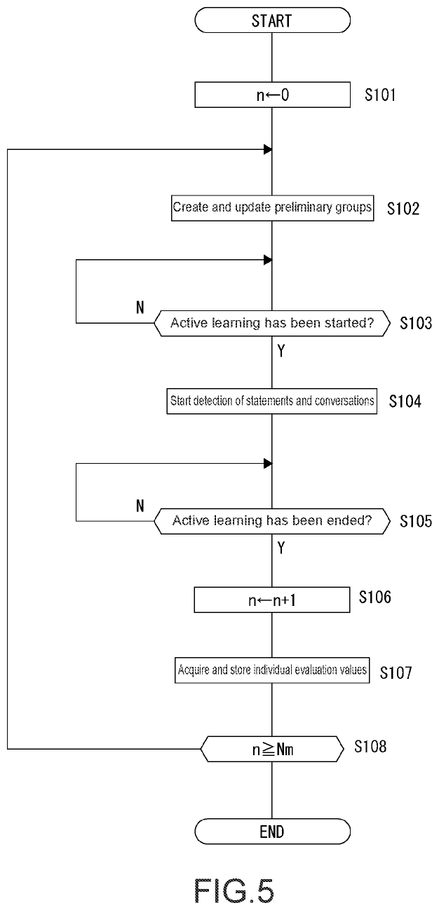

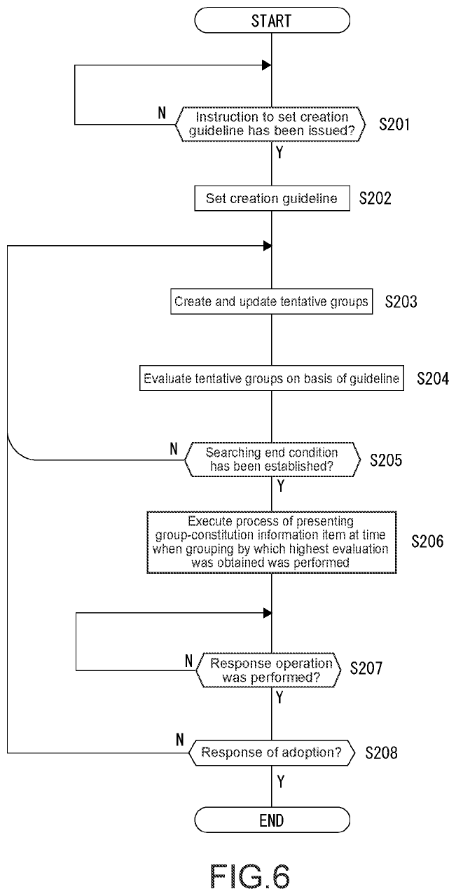

Now, with reference to the flowcharts of FIG. 5 and FIG. 6, an example of a specific processing procedure for implementing the group-creation assistance technique described above as an embodiment is described.

Note that, the processes shown in these FIG. 5 and FIG. 6 are executed by the control unit 14 in accordance with the programs stored in the above-described ROM and the like.

FIG. 5 is a flowchart showing processes to be executed for acquiring the individual evaluation values “v.” In this example, of the individual evaluation values “v,” the statement time period v1, the number of conversations v2, the ability evaluation value v3, and the final-deliverable evaluation value v4 (that is, evaluation values to be influenced by the identifier “n” of the number of times of the implementation) are evaluation values to be acquired at each of the times (first time to Nm-th time) of the active learning to be implemented as the preliminaries.

First, in Step S101, the control unit 14 resets the identifier “n” of the number of times of the implementation to zero. Then, in Step S102, the control unit 14 executes a process of creating and updating preliminary groups. Specifically, the control unit 14 newly creates the G groups such that all the K students belong to any of the G groups. The groups to be newly created in the process of creating and updating the preliminary groups are created in a manner that the group constitutions do not overlap with each other at least in the implementation of the first time to the Nm-th time of the active learning.

In this example, the active learning is implemented with use of the constitutions of the groups newly created in Step S102.

In Step S103 subsequent to Step S102, the control unit 14 waits for a start of the active learning. Whether or not the active learning has been started can be determined on the basis of, for example, the operation by the user such as the teacher. Alternatively, whether or not the active learning has been started may be determined also on the basis of results of analyses of the images taken by the cameras 2 or the voice signals detected by the microphones 3.

When the control unit 14 determines that the active learning has been started, in Step S104, the control unit 14 executes a process of starting the detection of statements and conversations. Specifically, the control unit 14 instructs the image processing unit 11, the voice processing unit 12, and the conversation detection unit 13 to start the detection of the respective statements and the respective conversations of the students.

In Step S105 subsequent to Step S104, the control unit 14 waits for an end of the active learning. Whether or not the active learning has been ended can be determined on the basis of, for example, the operation by the user such as the teacher, or may be determined also on the basis of the results of the analyses of the images taken by the cameras 2 or the voice signals detected by the microphones 3.

When the control unit 14 determines that the active learning has been ended, the control unit 14 increments in Step S106 the identifier “n” of the number of times of the implementation by one, and executes in Step S107 a process of acquiring and storing the individual evaluation values “v.” In this process of Step S107, the control unit 14 calculates the statement time period v1 and the number of conversations v2 of each of the students on the basis of the results of the statement detection by the voice processing unit 12 and of the results of the conversation detection by the conversation detection unit 13, and stores these evaluation values to the memory 15. In addition, in the process of Step S107, the control unit 14 accepts input of the numerical information items about the ability evaluation value v3 and the final-deliverable evaluation value v4 from the user such as the teacher, and stores these numerical information items to the memory 15.

In Step S108 subsequent to Step S107, the control unit 14 determines whether or not the identifier “n” of the number of times of the implementation is Nm or more, and returns the procedure to Step S102 when the identifier “n” of the number of times of the implementation is less than Nm. In this way, the individual evaluation values v1 to v4 are acquired and stored in each of the times of the implementation of the active learning.

Meanwhile, when the identifier “n” of the number of times of the implementation is Nm or more, the control unit 14 ends the series of processes shown in FIG. 5.

Note that, in this example, the evaluation value v5 (number of times when a corresponding one of the students has ever been grouped into the same group with other ones of the students) is calculated by the control unit 14 on the basis of group-constitution information items (information items about combinations of the students in each of the groups) of the new groups obtained by the creation and update process of Step S102, and stored to the memory 15. In addition, the evaluation value v6 (differences in gender from other ones of the students) and the evaluation value v7 (differences in age from other ones of the students) are calculated by the control unit 14 on the basis of the input information items about the gender and the age of each of the students, and stored to the memory 15.

FIG. 6 is a flowchart showing processes to be executed at the time of implementing the active learning after the preliminaries. The processes shown in FIG. 6 are executed in each of the times of the implementation of the active learning after the preliminaries.

First, in Step S201, the control unit 14 waits for an instruction to set the creation guideline. In this example, instructions to set the creation guidelines are issued by the operations by the user. For example, the control unit 14 causes the display apparatus 4 or the mobile terminal 6 to display a selection screen of the creation guidelines, and accepts an operation of selecting any of the creation guidelines of all the creation guidelines displayed on the screen as an operation of the instruction to set the creation guideline.

When the instruction to set the creation guideline is issued, in Step S202, the control unit 14 sets the creation guideline. Specifically, the control unit 14 sets the creation guideline instructed in Step S201 as a creation guideline to be used for the group evaluation.

In Step S203 subsequent to Step S202, the control unit 14 executes the process of creating and updating the tentative groups. As described above, the update of the respective group constitutions of the tentative groups may be performed by regularly varying the parts of the current group constitutions, or by randomly updating the parts of the current group constitutions.

In Step S204 subsequent to Step S203, the control unit 14 evaluates the tentative groups on the basis of the guideline. Specifically, the control unit 14 evaluates the tentative groups on the basis of the creation guideline set in Step S202, thereby calculating the above-described group overall-evaluation value Eall. Note that, the technique to calculate the group overall-evaluation value Eall by evaluating all the tentative groups on the basis of the creation guideline has already been described, and hence redundant description thereof is omitted.

Then, in Step S205, the control unit 14 determines whether or not a searching end condition has been established, and returns the procedure to Step S203 when the searching end condition has not been established. The searching end condition herein refers to a condition of ending a search for a group constitution suited to the creation guideline, specifically, refers to a condition of ending repetition of the processes of Steps S203 and S204. As an example this searching end condition, it is conceivable to set a condition of executing the creation and update process of Step S203 a predetermined number of times or more.

Note that, a condition that the group overall-evaluation value Eall has stopped increasing also may be set as the searching end condition. Alternatively, an AND condition or an OR condition of the condition of executing the creation and update process of Step S203 the predetermined number of times or more and the condition that the group overall-evaluation value Eall has stopped increasing may be set.

When the control unit 14 determines in Step S205 that the searching end condition has been established, the control unit 14 advances the procedure to Step S206, and executes the process of presenting the group-constitution information item at the time when the grouping by which the highest evaluation was obtained was performed. Specifically, the control unit 14 causes the image generation unit 17 to generate the image containing, on a tentative-group basis, the respective identification-information items of the students constituting the groups at the time when the grouping of the tentative groups, by which the highest one of the group-overall-evaluation values Eall was obtained, was performed, and causes the display apparatus 4 or the mobile terminal 6 to present this image to the user such as the teacher.

Next, as a response-operation waiting process in Step S207, the control unit 14 executes a process of waiting for a response operation from the user in response to the information items presented in Step S206. Specifically, the control unit 14 accepts a response operation as to whether or not the group constitution presented in Step S206 is adopted.

When the response operation is performed, in Step S208, the control unit 14 determines whether or not a response indicates that the group constitution has been adopted. When the control unit 14 determines that the response operation is not an operation indicating a response of the adoption, that is, the response indicating that the group constitution has been adopted is not obtained, the control unit 14 returns the procedure to Step S203. In other words, in this case, the process of searching for the group constitution is executed again.

Meanwhile, when the control unit 14 determines that the response operation is the operation indicating the response of the adoption, that is, the response indicating that the group constitution has been adopted is obtained, the control unit 14 ends the series of processes shown in FIG. 6.

### 4. VARIOUS MODIFICATIONS

### 4-1. First Modification (Individual Evaluation Values)

In the above description, the evaluation values v1 to v7 are mentioned as examples of the individual evaluation values “v.” However, the individual evaluation values “v” are not limited to these examples.

Specifically, with respect to the creation guideline of, for example, “exploring diversity of the students” or “grouping students having the same tendency with each other,” instead of or together with any of the evaluation values v5 (number of times when a corresponding one of the students has ever been grouped into the same group with other ones of the students), v6 (gender), and v7 (age), other evaluation values of the student, such as evaluation values relating to which courses the student takes, academic achievement, a qualification, the gender, the nationality, a use language, a religion, and the like of the student also may be used.

At this time, for example, with regard to which courses the student takes, it is conceivable to use evaluation values such as “0” and “1” that indicate, for each subject that the student takes, whether each of the other students takes the same subject. With regard to the academic achievement, it is conceivable to use, for example, evaluation values indicating differences in academic achievement of each of the taken subjects from each of the other students (such as differences, for example, in evaluation on the scale of 1 to 5). In addition, with regard to the qualification, the gender, the nationality, the use language, and the religion, similar to the evaluation value v6, it is conceivable to use the evaluation values “0” and “1” that indicate whether or not their evaluation values match with those of each of the other students.

Note that, of the individual evaluation values “v,” the statement time period v1 and the number of conversations v2 are evaluation values that can be acquired from the information items detected by the cameras 2 and the microphones 3, and hence can each be regarded also as an evaluation value detectable by an apparatus.

Further, the ability evaluation value v3 and the final-deliverable evaluation value v4 are assumed to be input, for example, by the teacher, and hence can each be regarded also as an evaluation value to be manually input.

The evaluation value v5 can be regarded also as an evaluation value relating to a history of the group constitution, and more broadly, can be regarded also as something that belongs to the evaluation value relating to the group constitution.

The above-mentioned evaluation values relating to the academic achievement and the qualification can each be regarded also as an evaluation value relating to a skill of the student.

Still further, of the individual evaluation values “v,” the evaluation values v1 to v5 can each be regarded also as a group-relevant evaluation value in a sense of being an evaluation value to be obtained through the group activities (group activities in the groups to be evaluated by the group evaluation unit F2). Meanwhile, the evaluation values v6 and v7 and the above-mentioned evaluation values relating to which courses the student takes, the academic achievement, the qualification, the gender, the nationality, the use language, and the religion of the student can each be regarded also as a group-irrelevant evaluation value in a sense of being an evaluation value to be obtained without the group activities.

Note that, as the evaluation values relating to the group constitution, not only the evaluation value v5 but also evaluation values relating, for example, to roles of the students in the group (such as the facilitator, a recorder, a timekeeper, and the like) may be used.

### 4-2. Second Modification (Creation Guideline)

In the above-described example, the group evaluation is performed by setting only one of the group creation guidelines. However, the plurality of creation guidelines may be simultaneously set. When the plurality of creation guidelines is set, priorities of the guidelines are respectively set in advance. In this case, the tentative groups are evaluated by calculating the group overall-evaluation values Eall in accordance respectively with the preset guidelines. Then, the calculated group-overall-evaluation values Eall are added up with weights in accordance with the respective priorities of the guidelines.

Note that, a common one of the group-creation guidelines may be maintained throughout the predetermined plurality of times of the active learning. However, in order that finally-desirable evaluation is performed, the group creation guidelines may be switched in accordance with the number of times of the implementation of the active learning.

For example, at a stage when the active learning has not yet been implemented a sufficient number of times, the guideline of “exploring diversity of the students” is set to evaluate the students under various conditions. With this, advantages of the students are assessed.

Then, when the number of times of the implementation increases, the guideline is shifted to the guideline of “grouping students having the same tendency with each other.” Specifically, students who make long statements are grouped into the same group, or students who make short statements are grouped into the same group such that, for example, how the statement time period of each of the students varies is checked.

At the last and preceding stages, the guideline of “grouping competent students with each other” is set. This enables checking what kind of situation occurs if competent students are in the same group, thereby facilitating final evaluation of the students.

Note that, although the guidelines are switched three times by the technique described herein, the number of times to switch the guidelines may arbitrarily set.

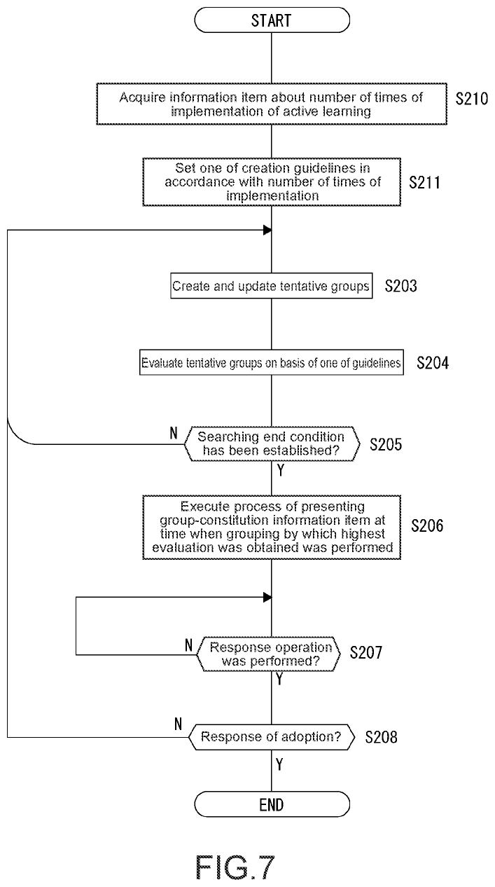

With reference to the flowchart of FIG. 7, processes as a second modification, which should be executed correspondingly to the case where the creation guidelines are switched in accordance with the number of times of the implementation as described above, are set.

Note that, in the following description, processes similar to the processes having already been described are denoted by the same step numbers to omit description thereof.

In this case, in Step S210, the control unit 14 acquires an information item about the number of times of the implementation of the active learning. This information item about the number of times of the implementation may be counted by the control unit 14 each time the control unit 14 executes the procedure shown in FIG. 7, or may be input by the user.

Then, in Step S211 subsequent to Step S210, the control unit 14 sets one of the creation guidelines in accordance with the number of times of the implementation. For example, in the above-described exemplary case, the control unit 14 sets the guideline of “exploring diversity of the students” when the number of times of the implementation is less than a first threshold, and sets the guideline of “grouping students having the same tendency with each other” when the number of times of the implementation is equal to or more than the first threshold and less than a second threshold (note that, second threshold>first threshold). Then, the control unit 14 sets the guideline of “grouping competent students with each other” when the number of times of the implementation is equal to or more than the second threshold.

The control unit 14 in this case advances the procedure to Step S203 after executing the process of Step S211. The processes of Step S203 and subsequent Steps are similar to those in FIG. 6, and hence description thereof is omitted.

Note that, although the switching of the guidelines in accordance with the number of times of the implementation is automatically performed by the information processing apparatus 1 in the above description, the user may instruct the information processing apparatus 1 to perform the switching of the guidelines in accordance with the number of times of the implementation.

### 4-3. Third Modification

In the examples mentioned in the above description, the information items about the combinations of the students in each of the groups are presented as the group-constitution information item relating to one of the groupings, which is selected on the basis of the results of the evaluation (such as grouping by which the highest one of the group-overall-evaluation values Eall was obtained). The group-constitution information item may contain information items about respective arrangement positions of the students in the group, such as an information item about a seating order in the group.

Presentation of the information items about the arrangement positions such as the seating order saves the user such as the teacher from the trouble of having to arrange relationships each time between the students in each of the groups. In other words, a burden on the user can be reduced.

In addition, for example, by arranging students who often have conversations with each other in the same group, for example, away from or close to each other, how the individual evaluation values “v” vary also can be checked.

### 4-4. Fourth Modification

With regard to the creation of the tentative groups, techniques to create the tentative groups may be switched in accordance with the creation guidelines.

For example, when the guideline of “exploring diversity of the students” has been set, the tentative groups are created by randomly combining the students with each other. Meanwhile, when the guideline of “grouping competent students with each other” has been set, some of the tentative groups are created only with students each with the ability evaluation value v3 of a certain value or more, and the rest of the tentative groups are created by randomly combining students each with the ability evaluation value v3 of less than the certain value. It is conceivable to switch the techniques in such a way to create the tentative groups in accordance with the creation guidelines.

Such switching of the techniques to create the tentative groups in accordance with the preset creation guidelines enables proper adoption of the techniques to create the tentative groups in accordance with types of the creation guidelines. As a result, efficiency in searching for group constitutions suited to the creation guidelines can be increased.

### 4-5. Fifth Modification

Further, with regard to the creation of the tentative groups, it is conceivable to allow the user such as the teacher to designate a part of a constitution of one or a plurality of groups.

In this case, for example, the user such as the teacher designates the part of the constitution of the one or the plurality of groups, for example, a combination of an entirety of a certain one group.

In a manner that the part of the constitution designated in this way is maintained, the control unit 14 executes the creation and update process of Step S203.

This enables the teacher or the like to fix the part of the group constitution.

In addition, at the time of the creation of the tentative groups, parameters of the students to be put into different combinations can be reduced. As a result, a burden of the processes of the updates can be reduced.

Still further, when the teacher or the like wants to fix the part of the group constitution as described above, it is troublesome for the teacher or the like to issue an instruction to perform the fixation of this constitution in each of the times of the implementation of the active learning. Thus, this constitution may be registered with the information processing apparatus 1. As an example, it is conceivable to allow the teacher or the like to register combinations of recommended students and combinations of unrecommended students. Specifically, as an example of the combinations of the recommended students, there may be mentioned a combination of a certain one of the students and a certain another one of the students, who are likely to stimulate discussions if grouped with each other. As an example of the combinations of the unrecommended students, there may be mentioned a combination of a certain one of the students and a certain another one of the students, who are uncongenial to each other to, for example, quarrel if grouped with each other.

The control unit 14 accepts an operation of designating the combinations of the recommended students and the combinations of the unrecommended students, and stores an information item of a designated one of the combinations of the students to the memory 15 in response to the designating operation.

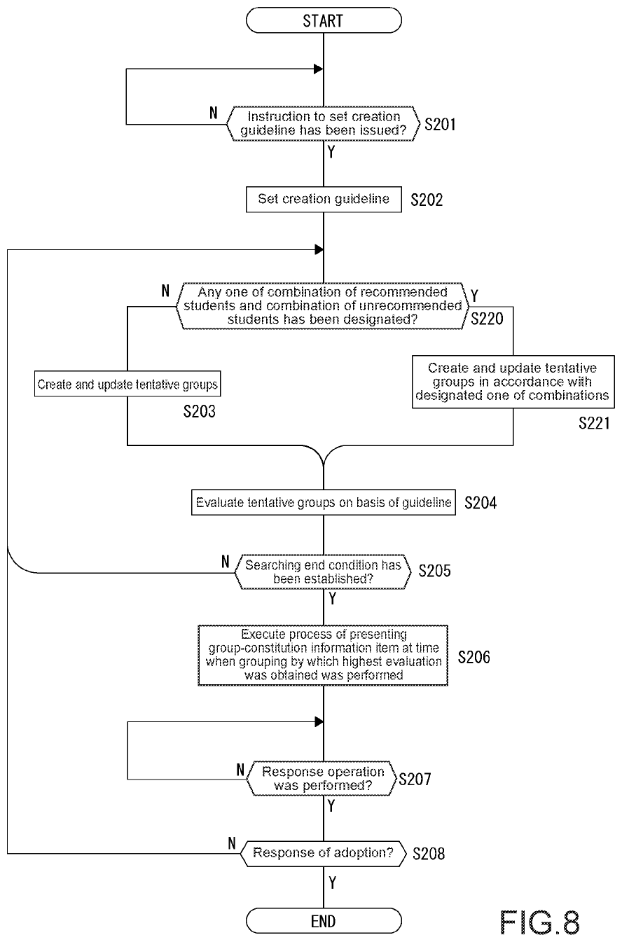

FIG. 8 is a flowchart showing processes as a fifth modification for creating the tentative groups in accordance with the combination of the recommended students and the combination of the unrecommended students as described above.

In this case, after the creation guideline has been set in Step S202, the control unit 14 determines in Step S220 whether or not any one of the combination of the recommended students and the combination of the unrecommended students has been designated. When none of the combinations has been designated, the control unit 14 advances the procedure to Step S203 to execute the process of creating and updating the tentative groups, and then executes the processes of Step S204 and subsequent Steps.

Meanwhile, when any one of the combinations has been designated, the control unit 14 advances the procedure to Step S221 to execute a process of creating and updating the tentative groups in accordance with the designated one of the combinations. Specifically, when the combination of the recommended students has been designated, the control unit 14 creates new tentative groups in a manner that a condition of grouping the students in the designated combination into the same group is satisfied. When the combination of the unrecommended students has been designated, the control unit 14 creates new tentative groups in a manner that a condition of separating the students in the designated combination into different groups is satisfied.

Also after the process of Step S221 has been executed, the control unit 14 executes the processes of Step S204 and subsequent Steps. When the control unit 14 in this case determines in Step S208 that the response indicating that the group constitution has been adopted is not obtained, the control unit 14 returns the procedure to Step S220. Specifically, when the combination of the recommended students or the combination of the unrecommended students has been designated, the control unit 14 updates the grouping in the manner that the condition of grouping the students in the designated combination into the same group, or the condition of separating the students in the designated combination into different groups is satisfied.

Note that, once the combination has been designated, an information item about the designated combination of the recommended students, or an information item about the designated combination of the unrecommended students is maintained unless an operation of changing content of the designation or an operation of cancelling the designation is performed by the user.

### 4-6. Sixth Modification

The above description has been made on a premise that each of the times of the active learning is implemented while maintaining the same group constitutions. However, the group constitutions may be changed during the active learning. In that case, the tentative groups may be created on the basis of individual evaluation values “v” acquired in previous times of the active learning, or may be created on the basis of individual evaluation values “v” acquired partway in a current time of the active learning.

### 4-7. Seventh Modification

In the above description, the individual evaluation values “v” are used for the evaluation of the tentative groups. However, the individual evaluation values “v” may be used for final evaluation of the students. In this case, the individual evaluation values “v” (v1 to v7) exemplified above are calculated with use of weighting coefficients for individual final evaluation. These weights may be preset, or may be corrected by the user such as the teacher. For example, in the evaluation of the students, the weights of, for example, the evaluation value v3 and the evaluation value v4 to be obtained by evaluation by the teacher himself/herself are set high, and the weights of, for example, the evaluation values v5, v6, and v7 are set low because the information items, for example, about the number of times when a corresponding one of the students has ever been grouped into the same group with other ones of the students, and about who the other ones of the students are, are not significantly relevant to the evaluation. In addition, in the active learning, a large number of statements can be a standard for a determination that a communication ability is high, and hence the weights of the statement time period v1 and the number of conversations v2 may be set high. However, having conversations with all the various members is more desirable than merely setting the statement time period v1 and the number of conversations v2 high, and hence variances of the statement time period v1 and the number of conversations v2 with respect to the number of times of the active learning may be taken into account. For example, an individual evaluation value E(k,v1) based on the statement time period v1 is calculated as follows.

First, an average value Ave and a variance Var of the statement time period v1 of a student “k” with respect to the number of times of the active learning is calculated.

Ave(k)=1/N*Σ^{N}ₙ₌₁v1(n,k)

Var(k)=1/N*Σ^{N}ₙ₌₁(Ave−v1(n,k))²

Then, an evaluation value of the student “k” is calculated from the obtained average value and the variance.

E(k,v1)=Ave(k)−ρVar(k)

Note that, “ρ” is a preset weighting coefficient. In this equation, the evaluation increases when the average value of the statement time period in each of the times of the active learning is large. In addition, the evaluation value increases also when the variance of the statement time period is small, that is, when the student “k” constantly and evenly makes statements. The number of conversations can be similarly calculated. However, as for the number of conversations, the information items about with whom the student “k” had conversations are also recorded, and hence variances with respect to the conversational partners also may be taken into account.

When the individual final evaluation is performed with use of the individual evaluation values “v” as described above, the individual evaluation values “v” may be used as they are, or a computational expression for the evaluation may be changed. In contrast, such an evaluation expression may be used for the evaluation of the tentative groups.

### 4-8. Eighth Modification

Although the values of the statement time period v1 and the number of conversations v2 are calculated in each of the times of the active learning in the above description, temporal information items may be added thereto. Specifically, as expressed by the following expressions, information items about when the student “k” made a statement and when the student “k” had a conversation are also linked.

v1′ (n, k, t): Statement Time Period

v2′ (n, k, m, t): Number of Conversations

This enables evaluation of biases of the statements and the conversations in each of the times of the active learning. Specifically, it is conceivable to increase the evaluation values as temporal biases of the statements and the conversations become smaller.

### 4-9. Ninth Modification

Not only the time periods or the number of times of the statements or the conversations of the student, but also content of the statements and the conversations may be taken into account. Although it is difficult to analyze all the content of the statements and the conversations with a computer, it is relatively easy to detect specific words (keywords). For example, keywords may be detected with the technology as disclosed in Patent Literature 3 cited above, and a student who makes a statement that contains keywords which are preset in accordance with content of the active learning by the teacher may be evaluated.

As a more specific example, it is conceivable to increase the ability evaluation value v3 of the student who makes the statement that contains the keywords. The ability evaluation value v3 in this case is out of a scope of the evaluation value to be input by a person.

Note that, the ability evaluation value v3 may be classified as two types of the evaluation value input by the teacher, and the evaluation value calculated from results of the analyses of the content of the statements and the conversations by the apparatus, such as the statement that contains the keywords as described above.

### 5. OTHER MODIFICATIONS

The present technology is not limited to the above-described specific examples, and various other modifications are conceivable.

Specifically, although the present technology is applied to the group activities in education at school in the examples mentioned in the above description, the present technology is suitably applicable also to group activities other than those in the education. More specifically, the present technology is applicable also to, for example, meetings in groups in a company or the like, group fora to be held, for example, as events, group work on production sites such as a factory, and the like.

Further, although the information processing apparatus according to the embodiment of the present technology in the above description is configured to generate the individual evaluation values “v,” the information processing apparatus according to the embodiment of the present technology may be configured also to perform the group evaluation by acquiring individual evaluation values “v” calculated on the outside of the apparatus.

Still further, although the information processing apparatus according to the embodiment of the present technology includes the guideline setting unit configured to set the group creation guidelines in the examples mentioned in the above description, the information items about the group creation guidelines to be used may be input from the outside of the information processing apparatus. Thus, the information processing apparatus need not necessarily be include the guideline setting unit.

### 6. SUMMARY OF EMBODIMENT

As described above, the information processing apparatus (same as F1) as the embodiment includes:
the group evaluation unit (same as F2) configured to evaluate a group on the basis of
   on the basis of the creation guideline for the group, and
   on the basis of the plurality of evaluation values associated with each of the plurality of members constituting the group; and
the presentation control unit (same as F3) configured to perform control to present the information items based on the results of the evaluation of the group by the group evaluation unit.

This enables not only creation of groups having specific features, but also assistance in creation of diverse groups in accordance with creation guidelines.

Thus, a capability in assisting the group creation can be increased.

Further, in the information processing apparatus as the embodiment,
the group is a group in which the plurality of members has conversations with each other.

This enables assistance in creating, in accordance with creation guidelines, diverse groups in which members have conversations with each other, such as groups at the times of discussions, fora, meetings, and the active learning.

Thus, a capability in assisting creation of the groups in which the members have conversations with each other can be increased.

Still further, in the information processing apparatus as the embodiment,
the group evaluation unit evaluates the group while increasing weighting to at least one or more evaluation values relevant to the creation guideline of the plurality of evaluation values higher than weighting to other ones of the plurality of evaluation values.

This enables proper evaluation of the group in accordance with the creation guideline for the group.

Thus, the capability in assisting the group creation can be increased.

Yet further, in the information processing apparatus as the embodiment,
the creation guideline is selected from the plurality of creation guidelines, and
the group evaluation unit evaluates the group while increasing weighting to at least one or more evaluation values relevant to the selected creation guideline of the plurality of evaluation values higher than the weighting to other ones of the plurality of evaluation values.

This enables proper evaluation of the group in accordance with the group creation guideline selected from the plurality of group creation guidelines.

Thus, the capability in assisting the group creation can be increased.

Yet further, in the information processing apparatus as the embodiment,
the creation guideline is the group activity guideline relating to the activity policy of the group.

The group activity guideline relating to the activity policy of the group can be translated into a guideline relating to an object of an activity of the group. As examples of the group activity guideline, the guidelines of prompting the members to express diverse opinions (exploring diversity of the members), stimulating discussions, prompting the members to have discussions in a certain direction, and the like may be mentioned.

This configuration enables evaluation of the group in accordance with such exemplified creation guidelines relating to the group activity policy. Thus, proper group creation in implementing a desired group-activity policy can be assisted.

Yet further, in the information processing apparatus as the embodiment,
the plurality of creation guidelines includes the deliverable guideline relating to the quality of deliverables from the group.

As examples of the deliverable guideline relating to the quality of the deliverables from the group, the guidelines for obtaining high-quality deliverables, more specifically, the guidelines such as the guideline of grouping competent students with each other may be mentioned.

Alternatively, the guidelines for enriching a specific knowledge, more specifically, the guidelines such as the guideline of grouping students who take a specific subject with each other may be mentioned.

This configuration enables evaluation of the group in accordance with such exemplified creation guidelines relating to the quality of the deliverables from the group. Thus, proper group creation for a case where group deliverables of desired quality should be obtained can be assisted.

Yet further, in the information processing apparatus as the embodiment,
the at least one or more evaluation values of the plurality of evaluation values include
   the evaluation value of the ability of a corresponding one of the plurality of members in a group activity, and
when the deliverable guideline has been selected as the creation guideline, the group evaluation unit evaluates the group while increasing weighting to the at least one or more evaluation values higher than the weighting to the other ones of the plurality of evaluation values.

This enables evaluation of the group based on the abilities of the members correspondingly to the case where the deliverable guideline has been selected as the creation guideline.

Thus, proper evaluation of the group in accordance with the group creation guideline based on the abilities of the members, such as the guideline of grouping competent students with each other, can be performed.

Yet further, in the information processing apparatus as the embodiment,
the at least one or more evaluation values of the plurality of evaluation values includes any of
   the statement time period of a corresponding one of the plurality of members,
   the number of conversations of the corresponding one of the plurality of members, and
   the number of times when the corresponding one of the plurality of members has ever been grouped into the same group with other ones of the plurality of members, and
when the guideline other than the deliverable guideline has been selected as the creation guideline, the group evaluation unit evaluates the group while increasing weighting to the at least one or more evaluation values higher than the weighting to the other ones of the plurality of evaluation values.

This enables evaluation of the group based on the statement time periods of the members, the numbers of conversations of the members, or the numbers of times when the members have ever been grouped into the same group with the other members correspondingly to the case where the guideline other than the deliverable guideline has been selected as the creation guideline.

Thus, the group can be properly evaluated in accordance with the group creation guidelines based on the evaluation values relating to the group activities of the members (statement time periods and numbers of conversations), and on the evaluation values relating to the history of the group constitution (numbers of times when the members have ever been grouped into the same group with the other members), such as the guidelines of grouping members who makes long statements with each other, grouping members who makes short statements with each other, grouping members who infrequently have conversations with each other, grouping members who frequently have conversations with each other, grouping members who have never been grouped into the same group with each other.

Yet further, in the information processing apparatus as the embodiment,
the group evaluation unit includes a tentative-group creation unit (control unit 14: refer to S203 and S221) configured to create the tentative group being the group that the group evaluation unit evaluates.

This saves the user from manually arranging the tentative groups.

Thus, the burden on the user can be reduced.

Yet further, in the information processing apparatus as the embodiment,
the tentative group that the tentative-group creation unit creates includes the plurality of tentative groups, and
the group evaluation unit
   evaluates, on the basis of the creation guideline, each of the plurality of tentative groups created by the tentative-group creation unit, and
   calculates the overall evaluation value of all the plurality of tentative groups on the basis of the evaluation of each of the plurality of tentative groups.

With this, the group overall-evaluation value indicating the results of the evaluation of all the groups can be obtained correspondingly to the case where the plurality of groups should be created.

Thus, at the time when the plurality of groups should be created, proper creation of the groups in accordance with the group creation guideline can be assisted.

Yet further, in the information processing apparatus as the embodiment,
the tentative-group creation unit sequentially updates the combinations of members in the tentative group, and
the group evaluation unit evaluates the tentative group in each of the updates.

This enables the search for the group constitution by which high evaluation is obtained.

Thus, the group creation in accordance with the guideline can be properly assisted.

Yet further, in the information processing apparatus as the embodiment,
the tentative-group creation unit randomly varies the combinations of the members in each of the updates.

This prevents a specific bias in combinational variation by the updates, such as a fixed grouping of specific members into the same group despite the repetitive updates.

Thus, the evaluation values of the groups can be made likely to fluctuate from update to update, and the searching performance at the time of searching for the group constitution suited to the creation guideline can be increased.

Yet further, in the information processing apparatus as the embodiment,
the updates by the tentative-group creation unit include the updates of regularly varying a part of a constitution of the tentative group.

This enables the number of times of the group updates that are needed for increasing the evaluation of the tentative groups to a certain value or more to be reduced less than that in the case of performing the updates of randomly varying the combinations of the members.

Thus, the efficiency in searching for group constitutions suited to the creation guideline can be increased.

Yet further, in the information processing apparatus as the embodiment,
the tentative-group creation unit ends the updates when the number of the times of the updates has reached a predetermined number of times or more (refer to S205).

This prevents unnecessary repetition of the updates.

Thus, the efficiency in searching for the group constitutions suited to the creation guideline can be increased.

Yet further, in the information processing apparatus as the embodiment,
the tentative-group creation unit switches the techniques to create the tentative group in accordance with the creation guideline (refer to Fourth Modification).

For example, when the guideline of exploring diversity of the members has been set, the tentative groups are created by randomly combining the members with each other. Meanwhile, when the guideline of grouping competent members with each other has been set, some of the tentative groups are created only with members each with the ability evaluation value of a certain value or more, and the rest of the tentative groups are created by randomly combining members each with the evaluation value of less than the certain value. In such a way, the techniques to create the tentative groups are switched in accordance with the creation guidelines.

Thus, proper techniques to create the tentative groups in accordance with the types of the creation guidelines can be adopted. As a result, the efficiency in searching for the group constitutions suited to the creation guidelines can be increased.

Yet further, in the information processing apparatus as the embodiment,
the tentative group that the tentative-group creation unit updates includes the plurality of tentative groups, and
the tentative-group creation unit updates the plurality of tentative groups in the manner that the condition that designated ones of the members are grouped into the same one of the plurality of tentative groups or separated into different ones of the plurality of tentative groups is satisfied (refer to Fifth Modification).

This enables the reliable grouping of recommended members in a combination into the same tentative group and the reliable separation of unrecommended members in a combination into different tentative groups.

Thus, usability can be increased.

Yet further, in the information processing apparatus as the embodiment,
the presentation control unit performs control to present the information item about the group constitution of the selected one of the plurality of tentative groups, the selected one being selected on the basis of the results of the evaluation by the group evaluation unit (refer to S206).

This enables the user to be presented with a group-constitution information item of a tentative group estimated to be suited to the creation guideline, such as a group-constitution information item of a tentative group that was evaluated highest.

Thus, the user is allowed to easily recognize the group constitution suited to the creation guideline, and performance of the group creation assistance can be increased.

Yet further, in the information processing apparatus as the embodiment,
the presentation control unit performs the control to present the information item about arrangement relationships between members in the selected one of the plurality of tentative groups as the information item about the group constitution of the selected one of the plurality of tentative groups (refer to Third Modification).

This saves the user from determining each time the arrangement relationships between the students in the group, such as the seating order of the members in the group.

Thus, the burden on the user can be reduced.

Further, an information processing method as another embodiment includes:
evaluating, by the information processing apparatus, a group
   on the basis of the creation guideline for the group, and
   on the basis of the plurality of evaluation values associated with each of the plurality of members constituting the group; and
performing, by the information processing apparatus, the control to present the information items based on the results of the evaluation of the group.

Also by such an information processing method as the other embodiment, functions and advantages similar to those of the above-described information processing apparatus as the embodiment can be obtained.

A program as still another embodiment causes the information processing apparatus to implement:
the function to evaluate a group
   on the basis of the creation guideline for the group, and
   on the basis of the plurality of evaluation values associated with each of the plurality of members constituting the group; and
the function to perform the control to present the information items based on the results of the evaluation of the group.

In other words, this program is the program for causing the information processing apparatus to execute the processes described with reference, for example, to FIG. 6, FIG. 7, and FIG. 8.

Such a program facilitates the implementation of the functions of the information processing apparatus as the embodiment.

Further, such a program may be stored in advance, for example, in a recording medium that is built in apparatuses such as a computer apparatus, or in a ROM in a microcomputer including a CPU. Alternatively, such a program may be stored temporarily or permanently in removable recording media such as a semiconductor memory, a memory card, an optical disk, a magneto-optical disk, and a magnetic disk. In addition, such removable recording media may be provided as what is called packaged software.

Still alternatively, such a program may be installed from the removable recording media into a personal computer or the like, or may be downloaded from a download site via networks such as a local area network (LAN) and the Internet.

Further, the advantages described herein are merely examples, and hence are not limited thereto. Thus, other advantages may be additionally obtained.

### 7. PRESENT TECHNOLOGY

Note that, the present technology may also adopt the configurations as follows.

(1)

An information processing apparatus, including:
a group evaluation unit configured to evaluate a group
   on the basis of a creation guideline for the group, and
   on the basis of a plurality of evaluation values associated with each of a plurality of members constituting the group; and
a presentation control unit configured to perform control to present information items based on results of the evaluation of the group by the group evaluation unit.

(2)

The information processing apparatus according to (1), in which
the group is a group in which the plurality of members has conversations with each other.

(3)

The information processing apparatus according to (1) or (2), in which
the group evaluation unit evaluates the group while increasing weighting to at least one or more evaluation values relevant to the creation guideline of the plurality of evaluation values higher than weighting to other ones of the plurality of evaluation values.

(4)

The information processing apparatus according to any of (1) to (3), in which
the creation guideline is selected from a plurality of creation guidelines, and
the group evaluation unit evaluates the group while increasing weighting to at least one or more evaluation values relevant to the selected creation guideline of the plurality of evaluation values higher than weighting to other ones of the plurality of evaluation values.

(5)

The information processing apparatus according to (4), in which
the creation guideline is a group activity guideline relating to an activity policy of the group.

(6)

The information processing apparatus according to (5), in which
the plurality of creation guidelines includes a deliverable guideline relating to quality of deliverables from the group.

(7)

The information processing apparatus according to (6), in which
the at least one or more evaluation values of the plurality of evaluation values include
   an evaluation value of an ability of a corresponding one of the plurality of members in a group activity, and
when the deliverable guideline has been selected as the creation guideline, the group evaluation unit evaluates the group while increasing weighting to the at least one or more evaluation values higher than the weighting to the other ones of the plurality of evaluation values.

(8)

The information processing apparatus according to (6), in which
the at least one or more evaluation values of the plurality of evaluation values includes any of
   a statement time period of a corresponding one of the plurality of members,
   a number of conversations of the corresponding one of the plurality of members, and
   a number of times when the corresponding one of the plurality of members has ever been grouped into a same group with other ones of the plurality of members, and
when a guideline other than the deliverable guideline has been selected as the creation guideline, the group evaluation unit evaluates the group while increasing weighting to the at least one or more evaluation values higher than the weighting to the other ones of the plurality of evaluation values.

(9)

The information processing apparatus according to any of (1) to (8), in which
the group evaluation unit includes a tentative-group creation unit configured to create a tentative group being a group that the group evaluation unit evaluates.

(10)

The information processing apparatus according to (9), in which
the tentative group that the tentative-group creation unit creates includes a plurality of tentative groups, and
the group evaluation unit
   evaluates, on the basis of the creation guideline, each of the plurality of tentative groups created by the tentative-group creation unit, and
   calculates an overall evaluation value of all the plurality of tentative groups on the basis of the evaluation of each of the plurality of tentative groups.

(11)

The information processing apparatus according to (9) or (10), in which
the tentative-group creation unit sequentially updates combinations of members in the tentative group, and
the group evaluation unit evaluates the tentative group in each of the updates.

(12)

The information processing apparatus according to (11), in which
the tentative-group creation unit randomly varies the combinations of the members in each of the updates.

(13)

The information processing apparatus according to (11), in which
the updates by the tentative-group creation unit include updates of regularly varying a part of a constitution of the tentative group.

(14)

The information processing apparatus according to any of (11) to (13), in which
the tentative-group creation unit ends the updates when a number of times of the updates has reached a predetermined number of times or more.

(15)

The information processing apparatus according to any of (9) to (14), in which
the tentative-group creation unit switches techniques to create the tentative group in accordance with the creation guideline.

(16)

The information processing apparatus according to any of (11) to (15), in which
the tentative group that the tentative-group creation unit updates includes a plurality of tentative groups, and
the tentative-group creation unit updates the plurality of tentative groups in a manner that a condition that designated ones of the members are grouped into a same one of the plurality of tentative groups or separated into different ones of the plurality of tentative groups is satisfied.

(17)

The information processing apparatus according to any of (11) to (16), in which
the presentation control unit performs control to present an information item about a group constitution of a selected one of the plurality of tentative groups, the selected one being selected on the basis of results of the evaluation by the group evaluation unit.

(18)

The information processing apparatus according to (17), in which
the presentation control unit performs control to present an information item about arrangement relationships between members in the selected one of the plurality of tentative groups as the information item about the group constitution of the selected one of the plurality of tentative groups.

### REFERENCE SIGNS LIST

1 Information processing apparatus
14 Control unit
15 Memory
16 Operation unit
17 Image generation unit
18 Display control unit
19 Communication unit
F1 Guideline setting unit
F2 Group evaluation unit
F3 Presentation control unit

It should be understood by those skilled in the art that various modifications, combinations, sub-combinations and alterations may occur depending on design requirements and other factors insofar as they are within the scope of the appended claims or the equivalents thereof.

1. An information processing apparatus, comprising:
a group evaluation unit configured to evaluate a group
on a basis of a creation guideline for the group, and
on a basis of a plurality of evaluation values associated with each of a plurality of members constituting the group; and
a presentation control unit configured to perform control to present information items based on results of the evaluation of the group by the group evaluation unit.

2. The information processing apparatus according to claim 1, wherein
the group is a group in which the plurality of members has conversations with each other.

3. The information processing apparatus according to claim 1, wherein
the group evaluation unit evaluates the group while increasing weighting to at least one or more evaluation values relevant to the creation guideline of the plurality of evaluation values higher than weighting to other ones of the plurality of evaluation values.

4. The information processing apparatus according to claim 1, wherein
the creation guideline is selected from a plurality of creation guidelines, and
the group evaluation unit evaluates the group while increasing weighting to at least one or more evaluation values relevant to the selected creation guideline of the plurality of evaluation values higher than weighting to other ones of the plurality of evaluation values.

5. The information processing apparatus according to claim 4, wherein
the creation guideline is a group activity guideline relating to an activity policy of the group.

6. The information processing apparatus according to claim 5, wherein
the plurality of creation guidelines includes a deliverable guideline relating to quality of deliverables from the group.

7. The information processing apparatus according to claim 6, wherein
the at least one or more evaluation values of the plurality of evaluation values include
an evaluation value of an ability of a corresponding one of the plurality of members in a group activity, and
when the deliverable guideline has been selected as the creation guideline, the group evaluation unit evaluates the group while increasing weighting to the at least one or more evaluation values higher than the weighting to the other ones of the plurality of evaluation values.

8. The information processing apparatus according to claim 6, wherein
the at least one or more evaluation values of the plurality of evaluation values includes any of
a statement time period of a corresponding one of the plurality of members,
a number of conversations of the corresponding one of the plurality of members, and
a number of times when the corresponding one of the plurality of members has ever been grouped into a same group with other ones of the plurality of members, and
when a guideline other than the deliverable guideline has been selected as the creation guideline, the group evaluation unit evaluates the group while increasing weighting to the at least one or more evaluation values higher than the weighting to the other ones of the plurality of evaluation values.

9. The information processing apparatus according to claim 1, wherein
the group evaluation unit includes a tentative-group creation unit configured to create a tentative group being a group that the group evaluation unit evaluates.

10. The information processing apparatus according to claim 9, wherein
the tentative group that the tentative-group creation unit creates includes a plurality of tentative groups, and
the group evaluation unit
evaluates, on the basis of the creation guideline, each of the plurality of tentative groups created by the tentative-group creation unit, and
calculates an overall evaluation value of all the plurality of tentative groups on the basis of the evaluation of each of the plurality of tentative groups.

11. The information processing apparatus according to claim 9, wherein
the tentative-group creation unit sequentially updates combinations of members in the tentative group, and
the group evaluation unit evaluates the tentative group in each of the updates.

12. The information processing apparatus according to claim 11, wherein
the tentative-group creation unit randomly varies the combinations of the members in each of the updates.

13. The information processing apparatus according to claim 11, wherein
the updates by the tentative-group creation unit include updates of regularly varying a part of a constitution of the tentative group.

14. The information processing apparatus according to claim 11, wherein
the tentative-group creation unit ends the updates when a number of times of the updates has reached a predetermined number of times or more.

15. The information processing apparatus according to claim 9, wherein
the tentative-group creation unit switches techniques to create the tentative group in accordance with the creation guideline.

16. The information processing apparatus according to claim 11, wherein
the tentative group that the tentative-group creation unit updates includes a plurality of tentative groups, and
the tentative-group creation unit updates the plurality of tentative groups in a manner that a condition that designated ones of the members are grouped into a same one of the plurality of tentative groups or separated into different ones of the plurality of tentative groups is satisfied.

17. The information processing apparatus according to claim 11, wherein
the presentation control unit performs control to present an information item about a group constitution of a selected one of the plurality of tentative groups, the selected one being selected on a basis of results of the evaluation by the group evaluation unit.

18. The information processing apparatus according to claim 17, wherein
the presentation control unit performs control to present an information item about arrangement relationships between members in the selected one of the plurality of tentative groups as the information item about the group constitution of the selected one of the plurality of tentative groups.

19. An information processing method, comprising:
evaluating, by an information processing apparatus, a group
on a basis of a creation guideline for the group, and
on a basis of a plurality of evaluation values associated with each of a plurality of members constituting the group; and
performing, by the information processing apparatus, control to present information items based on results of the evaluation of the group.

20. A program for causing an information processing apparatus to implement:
a function to evaluate a group
on a basis of a creation guideline for the group, and
on a basis of a plurality of evaluation values associated with each of a plurality of members constituting the group; and
a function to perform control to present information items based on results of the evaluation of the group.
